(19) United States
(12) Patent Application Publication
(10) Pub. No.: US 2013/0058725 A1
(43) Pub. Date: Mar. 7, 2013

(54) SYSTEM FOR EXTRACTING HEAT FROM AN EFFLUENT FLOWING IN A DUCT, AND HEAT EXCHANGER FOR SUCH A SYSTEM

(71) Applicant: Frédéric Duong, Pezilla La Riviere (FR)

(72) Inventor: Frédéric Duong, Pezilla La Riviere (FR)

(73) Assignee: LYONNAISE DES EAUX FRANCE, PARIS LA DEFENSE (FR)

(21) Appl. No.: 13/641,548

(22) PCT Filed: Apr. 20, 2011
(86) PCT No.: PCT/IB11/51722

§ 371 Date: Nov. 16, 2012

(30) Foreign Application Priority Data
Apr. 21, 2010 (FR) FR 1053045

(51) Int. Cl. F28F 13/12; G05D 23/00; F16L 59/15

(52) U.S. Cl. 405/184.2; 165/121; 165/287

(57) ABSTRACT

Disclosed is a system for extracting heat from an effluent duct (2), in particular a wastewater collection device, comprising, in the zones of the inner duct wall located above the effluent, heat exchanger tubes (3) which are exposed to the atmosphere in the duct and through which a heat transfer fluid flows to recover some of the sensible heat and of the latent condensation heat from the steam generated by the effluent. A forced-convection device (9) is provided to generate a movement of air sweeping across the surface of the effluent (1) and increase the evaporation rate of the effluent.

The invention relates to an installation for extracting heat from an effluent flowing in a duct, in particular for extracting heat from a main sewer.

Main sewers or ducts for evacuating wastewater transport dirty waters that are tepid or temperate because of their residential or tertiary provenance, or because of their provenance from collective or industrial activities: abattoirs, sports and leisure infrastructures, swimming pools, gymnasiums, etc.

The noticeable heat of these waters represents a source of energy that with advantageously be recovered for purposes of heating buildings, or producing hot domestic supply water, or any other thermal use, in combination with a heat pump.

DE 197 19 311 C5 shows a heat exchanger used to implement a method for extracting heat from an effluent. The elements of the heat exchanger are immersed in the effluent and may be in the form of metal plates closely following the bottom of the duct or in the form of U-shaped metal section pieces that are connected to pipes for the inlet and outlet of heat-transferring fluid. The heat exchangers are made essentially of metal parts, notably of stainless steel. Such exchangers are relatively costly to manufacture and use. These contact exchangers have their surface placed parallel to the flow of the effluent flowing in the duct. There is no obstacle on the route followed by the effluent and the risk of clogging the surface of the exchanger is reduced. However, a residual deposit may be produced locally.

This method of heat exchange with an effluent flowing in a duct requires a relatively large, opened-out length of contact because of the relatively small surface area in contact, and because of the relatively low temperature of the effluent.

The heat exchanger is an item of equipment fitted to the inside of the ducts and immersed in the effluent; even though these ducts are of large dimensions, installation is complicated because of the hydraulic connections that absolutely must be water-tight and because of the shape of the parts of the exchanger that must match the internal profile of the ducts.

DE 36 07 207 proposes, in a wastewater duct, an installation with heat exchanger of which a portion is situated above the effluent that flows in the duct.

The object of the invention is mainly to provide an installation making it possible to effectively extract heat from an effluent flowing in a duct, notably a main sewer, that is simple and economical to install. It is desirable that maintenance of the installation is easy.

According to the invention, an installation for extracting heat in an effluent duct, notably a main sewer, which comprises, on the areas of the internal wall of the duct situated above the effluent, at least one heat-exchange tube exposed to the atmosphere prevailing in the duct, through which a heat-transfer fluid travels to recover a portion of the noticeable heat and of the latent heat from condensation of the water vapor originating from the effluent, is characterized in that it comprises a forced-convection device for producing a movement of air which sweeps over the surface of the effluent and increases the evaporation rate of the effluent.

Several heat-exchange tubes are usually provided. Advantageously, the heat-exchange tubes are furnished with fins.

The forced-convection device is usually placed in the top portion of the duct, parallel to the heat-exchange tubes. The forced-convection device advantageously consists of at least one pipe supplied with recycled humid air or with outside air by a fan installed at one end of the pipe, outside the wastewater duct.

The pipe of the forced-convection device may comprise nozzles or slots or orifices to produce jets oriented toward the effluent flowing in the duct.

The forced-convection device may be slaved to a temperature probe and to a hygrostat placed in the duct so as to start the fan only when the temperature and humidity conditions are favorable.

Moreover, the installation may comprise, in the bottom of the duct, a heat exchanger which is immersed in the effluent. The heat exchanger is advantageously formed by coating of tubes with a sufficiently heat-conducting material poured around the tubes, and capable of hardening, the tubes being designed for the circulation of a heat-transfer fluid, the heat exchange with the effluent of the duct taking place through the molded coating, to the exclusion of any fitted mechanical part, the top surface of the poured material coming into direct contact with the effluent flowing in the duct.

The exchanger may be produced directly inside the duct by in-situ pouring of the coating material in order to embed the tubes therein, the material closely following the profile of the bottom portion of the duct.

Apart from the arrangements explained above, the invention consists of a certain number of other arrangements that will be dealt with more explicitly below with reference to exemplary embodiments described with reference to the appended drawings but which are in no way limiting. In these drawings:

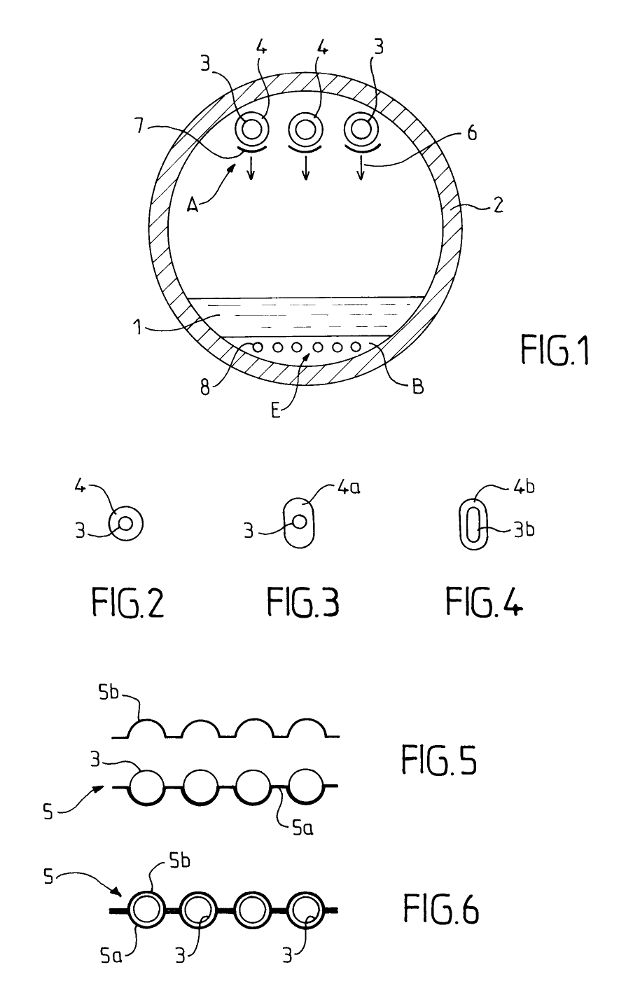

FIG. 1 is a vertical cross section of a wastewater duct comprising an installation for extracting heat according to the invention.

FIGS. 2, 3 and 4 are cross sections, on a smaller scale, of various forms of heat-exchange tubes for an installation according to the invention.

FIG. 5 is a cross-sectional diagram, on a larger scale, of a cluster of tubes and of a rack-shaped support, in the open position.

FIG. 6 is a cross-sectional diagram, similar to FIG. 5 of the cluster of tubes held in the rack in the closed position.

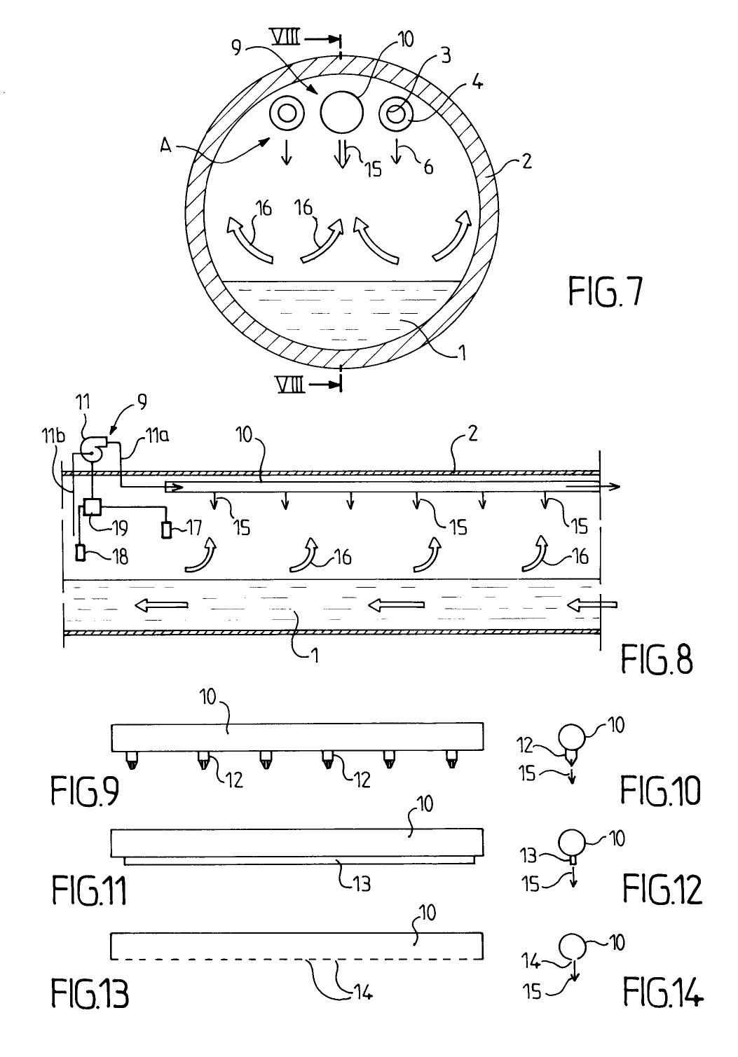

FIG. 7 is a vertical section similar to FIG. 1 of a wastewater duct comprising an installation for extracting heat with the forced-convection device, according to the invention.

FIG. 8 is a vertical longitudinal section on a smaller scale, along the line VIII-VIII of FIG. 7.

FIG. 9 is a side view of a tube with blowing nozzles for a forced-convection device.

FIG. 10 is a view from the left relative to FIG. 9.

FIG. 11 is a side view of a tube with a blowing slot for a forced-convection device.

FIG. 12 is a view from the left relative to FIG. 11.

FIG. 13 is a side view of a tube with blowing orifices for a forced-convection device, and

FIG. 14 is a view from the left relative to FIG. 13.

With reference to FIG. 1 of the drawings, an installation A can be seen for extracting heat from an effluent 1 flowing in a duct 2, more particularly a main sewer. This installation comprises heat-exchange tubes 3 arranged in a cluster, placed inside and in the top portion of the duct 2, outside the area of flow of the liquid effluent 1. The tubes 3 are attached to zones of the internal wall of the duct situated above the effluent and are exposed to the atmosphere prevailing in the duct 2. A heat-transfer fluid travels through the tubes 3 to recover a portion of the noticeable heat and of the latent heat from condensation of the water vapor originating from the effluent.

The tubes 3 are oriented parallel to the longitudinal direction of the duct, and are connected in parallel or in series to form a fluid circuit usually comprising a heat pump.

The tubes 3 may be externally smooth or comprise fitted fins to increase the exchange surface area. The fins may be spiraled, longitudinal, transverse, notably in a plane orthogonal to the axis of the tube, or annulated. According to FIGS. 1 and 2, the tubes 3 are of circular section and comprise fins 4 in the form of circular rings. According to FIG. 3, the tube 3 is of circular section, with oblong fins 4a. According to FIG. 4, the tube 3b is of oblong section with oblong fins 4b.

The tubes 3 may be previously attached in a spacer rack 5 comprising two half-shells 5a, 5b that can be seen in FIG. 5 comprising evenly-spaced semicircular housings. The half-shells 5a, 5b can be assembled, notably by snap-fitting, as illustrated in FIG. 6 to maintain the spacing between the tubes 3.

The tubes 3 may be made of metal or synthetic or plastic material. They may be rigid, semi-rigid or flexible. Advantageously, the tubes are suitable for being rolled up on a reel so that it is possible to install considerable lengths, notably of several tens of meters, in one piece without connectors.

The tubes 3 can be attached to the internal wall of the duct 2 by collars or quick-fastening clips. The tubes of each cluster can be connected in series or in parallel by compression sleeves or other rapid connectors that will also serve to ensure the free expansion between each cluster.

The section of the tubes 3 may be round, flattened or ovoid depending on the fabrication method and the materials used.

Because of the intense condensation of the water vapor contained in the atmosphere, or sky, of the duct 2, the condensed water on the exchange surfaces of the tubes 3 will trickle directly into the duct 1 and fall back into the effluent as schematized by arrows 6.

Advantageously, channels 7 situated beneath the tubes 3 are provided to collect this condensed water and direct it toward a return area in the effluent.

In addition to the tubes 3 situated outside the effluent, it is possible to provide a heat exchanger E situated in the bottom portion of the duct 2 in order to be immersed in the effluent. This exchanger E comprises tubes 8 in which a heat-transfer fluid also flows for extracting heat from the effluent 1. The exchanger E may be produced in situ in the bottom of the duct 2, by pouring a relatively heat-conductive material B, suitable for hardening, around the tubes 8, for example a cement laden with additives promoting thermal conductivity, or a synthetic resin.

With reference to FIGS. 7 and 8, an installation A according to the invention can be seen that comprises a forced-convection device 9 for promoting the evaporation of the water from the effluent 1. The device 9 comprises at least one pipe 10, each pipe consisting of a tube, spiraled or welded, notably made of plastic, or of aluminum or of galvanized steel.

The device 9 also comprises a fan 11 (FIG. 8) installed outside the duct 2. The discharge from the fan 11 is connected to an inlet end of the pipe 10 by a connection nozzle 11a which passes through the wall of the duct 2, from the outside to the inside. The suction of the fan 11 is connected via a nozzle 11b, which also passes through the wall, to the inside of the duct 2.

As a variant, the fan 11 could directly suck air outside the duct 2.

The pipe 10 is thus supplied with recycled humid air originating from the atmosphere of the duct 2, or with outside air.

The forced-convection device 9 comprises nozzles 12 (FIGS. 9, 10) or a slot 13 (FIGS. 11, 12) or orifices 14 (FIGS. 13, 14) to produce air jets oriented toward the effluent 1 flowing in the duct. Preferably, the pipe 10 is installed in the top portion of the duct 2 and the air jets are directed downward as schematized by the arrows 15. The air movement thus produced in the duct 2 ensures that the surface of the effluent is swept as schematized by arrows 16 and increases the rate of evaporation of the effluent.

The air jets produced by the nozzles 12 or the slots 13 or the orifices 14 have a conical shape, opening out in the direction of the effluent.

In order to limit the section of the air-delivery pipe 10 and to ensure a balance of the flow rate all along the latter, the air pressure in the pipe will preferably be higher than 500 daPA.

The forced-convection device 9 is advantageously slaved to a temperature probe 17 and to a hygrostat 18 placed in the duct. In particular, the outlet of the probe 17 and that of the hygrostat 18 are connected to a control box 19 for the fan 11 so that the starting of the mechanical ventilation by switching on the fan 11, will occur only when the temperature and humidity conditions in the duct 2 are favorable.

In the event of a great length of pipe 10, the latter would be subdivided into sections, for example approximately 50 m long, and several fans would be installed, notably one fan 11 for each 50 m section.

An installation A according to the invention, with heat-exchange tubes 3 fitted inside the duct 2, above the effluent 1, has many advantages.

It is suited to all the profiles of duct, ovoid, curvilinear and rectangular. The tubes 3 used for the installation are ordinary tubes that are not very costly. The installation does not require the manufacture of special and dished mechanical parts. The components can be inserted into the duct 2 without handling means because of their low weight.

The continuity of the exchanger formed by the tubes 3 over considerable lengths of several tens of meters, without hydraulic connection, reduces the risk of leakage. The space requirement inside the ducts is low and no obstacle is created on the path of the effluent.

Mounting of the installation is relatively easy and quick. An on-site repair requires few handling and toolage means and can be carried out at short notice.

The clusters of tubes can be connected by standard compression seals and, in the event of accidental breakage, a rapid repair can be carried out with sleeves and breastplates.

The tubes 3 forming the installation have a low thermal inertia and are not subject to the risk of abrasion due to the effluent since they are placed outside this effluent.

The invention may be applied to the recovery of heat from fluids that are laden and/or corrosive, or abrasive, in particular in urban sanitation systems, and in all residential, tertiary or industrial utilities that evacuate warm effluents: swimming pools, schools, universities, administrative buildings, food, chemical and petrochemical industries.

1-9. (canceled)

10. An installation for extracting heat in an effluent duct, notably a main sewer, which comprises, on the areas of the internal wall of the duct situated above the effluent, at least one heat-exchange tube exposed to the atmosphere prevailing in the duct, through which a heat-transfer fluid travels to recover a portion of the noticeable heat and of the latent heat from condensation of the water vapor originating from the effluent, and further comprising a forced-convection device for producing a movement of air which sweeps over the surface of the effluent and to increase the evaporation rate of the effluent.

11. The installation as claimed in claim 10, wherein the heat-exchange tube or tubes are furnished with fins.

12. The installation as claimed in claim 10, wherein the forced-convection device is placed in the top portion of the duct, parallel to the heat-exchange tubes.

13. The installation as claimed in claim 12, wherein the forced-convection device consists of at least one pipe supplied with recycled humid air, or with outside air, by a fan installed at one end of the pipe, outside the wastewater duct.

14. The installation as claimed in claim 13, wherein the pipe of the forced-convection device comprises nozzles or slots or orifices to produce jets oriented toward the effluent flowing in the duct.

15. The installation as claimed in claim 13, wherein the forced-convection device is slaved to a temperature probe and to a hygrostat placed in the duct so as to start the fan only when the temperature and humidity conditions are favorable.

16. The installation as claimed in claim 10, further comprising, in the bottom of the duct, a heat exchanger which is immersed in the effluent.

17. The installation as claimed in claim 16, wherein the heat exchanger is formed by coating of tubes with a sufficiently heat-conducting material poured around the tubes, and capable of hardening, the tubes being designed for the circulation of a heat-transfer fluid, the heat exchange with the effluent of the duct taking place through the molded coating, to the exclusion of any fitted mechanical part, the top surface of the poured material coming into direct contact with the effluent flowing in the duct.

18. The installation as claimed in claim 16, wherein the exchanger is produced directly inside the duct by in-situ pouring of the coating material in order to embed the tubes therein, the material closely following the profile of the bottom portion of the duct.
